(19) United States
(12) Patent Application Publication
(10) Pub. No.: US 2025/0026875 A1
(43) Pub. Date: Jan. 23, 2025

(54) LIQUID COMPLEX COACERVATES, ARTICLES DERIVED THEREFROM, AND METHODS FOR THE MANUFACTURE THEREOF

(71) Applicants: UNIVERSITY OF MASSACHUSETTS, Boston, MA (US); BASF SE, Ludwigshafen am Rhein (DE)

(72) Inventors: Sarah L. PERRY, Belchertown, MA (US); Isaac A. RAMÍREZ MARRERO, Sunderland, MA (US); Rupert KONRADI, Tarrytown, NY (US); Bernhard Ulrich VON VACANO, Ludwigshafen (DE); Nadine KAISER, Ludwigshafen (DE); Rainer GUTZLER, Dudenhofen (DE)

(21) Appl. No.: 18/708,368

(22) PCT Filed: Nov. 9, 2022
(86) PCT No.: PCT/US2022/049358

§ 371 Date: May 8, 2024

Related U.S. Application Data
(60) Provisional application No. 63/277,715, filed on Nov. 10, 2021.

(51) Int. Cl. C08F 220/06; C08F 220/34; C08F 220/56; C09D 133/02; C09D 133/14

(52) U.S. Cl. CPC C08F 220/06; C08F 220/34; C08F 220/56; C09D 133/02; C09D 133/14

(57) ABSTRACT

A cured product of a liquid complex coacervate includes a macroion phase of a polyanion, a polycation, and a salt; wherein the polyanion has repeating units including one or more of a carboxylate group, a sulfonate group, a phosphonate group, a sulfate group, or a phosphate group; and wherein the polycation has repeating units including one or more of a nitrogen-containing cationic group, a phosphorus-containing cationic group, or a sulfur-containing cationic group; provided that when the polycation is poly(diallyldimethyl ammonium), the poly anion is not polystyrene sulfonate, or when the polyanion is polystyrene sulfonate, the polycation is not poly(diallyldimethyl ammonium). Methods of forming coatings are also disclosed.

### CROSS REFERENCE TO RELATED APPLICATION

This application claims priority to U.S. Provisional Patent Application No. 63/277,715, filed on Nov. 10, 2021, in the United States Patent and Trademark Office, and all the benefits accruing therefrom under 35 U.S.C. § 119, the content of which is incorporated herein in its entirety by reference.

### BACKGROUND

Charged polyelectrolytes represent an example of a typical water-soluble polymer. However, repulsive forces between charges along the polymer chain can lead to high viscosity, particularly as compared to neutral polymer solutions at an equivalent polymer concentration. This high viscosity can lead to challenges in processing such solutions. Furthermore, simple solutions of water-soluble polymers generally require crosslinking or additional post-processing in order to provide a chemically robust material. Organic solvents and crosslinking agents used for such processing can limit the utility of these materials.

Complex coacervates are dense, polyelectrolyte-rich liquids that result from the electrostatic complexation of oppositely charged polymers or other macroions in water. Their self-assembly is driven by both electrostatic interactions and entropy. Furthermore, the low surface tension of coacervates with water can facilitate their use in various applications.

Although complex coacervation as a term generally refers to the formation of a liquid phase, it is also possible to form solid complexes. Historically, these solid complexes were considered to be intractable from a processing and use perspective because they do not melt and/or dissolve in organic solvents as is common with more “traditional” plastics.

There remains a need in the art for liquid complex coacervates, which can be useful for a variety of applications, and in particular for forming new solid polymer-containing materials. It would be further advantageous to provide complex coacervate systems which offer the opportunity for controlling the mechanical properties of the final articles (e.g., solid polymer films, coating, and the like).

### SUMMARY

A cured product of a liquid complex coacervate includes a macroion phase comprising a polyanion, a polycation, and a salt; wherein the polyanion comprises repeating units comprising one or more of a carboxylate group, a sulfonate group, a phosphonate group, a sulfate group, or a phosphate group; and wherein the polycation comprises repeating units comprising one or more of a nitrogen-containing cationic group, a phosphorus-containing cationic group, or a sulfur-containing cationic group; provided that when the polycation is poly(diallyldimethyl ammonium), the polyanion is not polystyrene sulfonate, or when the polyanion is polystyrene sulfonate, the polycation is not poly(diallyldimethyl ammonium).

An article comprises the cured product.

A method of forming the cured product comprises combining a polyanion, a polycation and a salt to provide a liquid complex coacervate; and curing the liquid complex coacervate to provide the cured product.

A method of forming a coating on a substrate comprises combining a polyanion, a polycation and a salt to provide a liquid complex coacervate; depositing the liquid complex coacervate on at least a portion of the substrate; and curing the deposited liquid complex coacervate to provide the coating; wherein the polyanion comprises repeating units comprising one or more of a carboxylate group, a sulfonate group, or a phosphonate group; and wherein the polycation comprises repeating units comprising one or more of a nitrogen-containing cationic group, a phosphorus-containing cationic group, or a sulfur-containing cationic group, provided that when the polycation is poly(diallyldimethyl ammonium), the polyanion is not polystyrene sulfonate, or when the polyanion is polystyrene sulfonate, the polycation is not poly(diallyldimethyl ammonium).

A coating prepared by the method represents another aspect of the present disclosure.

A precursor system comprises a first component comprising a polyanion comprises repeating units comprising one or more of a carboxylate group, a sulfonate group, a phosphonate group, a sulfate group, or a phosphate group, and a second component comprising a polycation comprises repeating units comprising one or more of a nitrogen-containing cationic group, a phosphorus-containing cationic group, or a sulfur-containing cationic group; wherein at least one of the first component or the second component comprise a salt.

A liquid complex coacervate product comprises a macroion phase comprises a polyanion, a polycation, and a salt; and optionally, a water-rich phase.

The above described and other features are exemplified by the following figures and detailed description.

### BRIEF DESCRIPTION OF THE DRAWINGS

The following figures are exemplary embodiments.

FIG. 1 is a schematic depiction of processing liquid complex coacervates into films.

FIG. 2 is (a) a graph of stress (MPa) versus strain (%) for PMAA-PTMAEMA films with no salt and without the rinsing step to remove the salt (50, 100 and 150 mM KBr). (b)-(e) show tensile test parameters extrapolated from the tensile tests where, E is Young's Modulus, UTS is Ultimate Tensile Strength, SaF is Strain at Failure and WtF is Work to Failure

FIG. 3 is a graph of stress (MPa) versus strain (%) for PMAA-PTMAEMA films at different temperatures and constant relative humidity of 40%. b-e show tensile test parameters extrapolated from the tensile tests where, E is Young's Modulus, UTS is Ultimate Tensile Strength, SaF is Strain at Failure and WtF is Work to Failure.

FIG. 4 is a graph of stress (MPa) versus strain (%) for PMAA-PTMAEMA films at different relative humidities and constant temperature of 25° C. b-e show tensile test parameters extrapolated from the tensile tests where, E is Young's Modulus, UTS is Ultimate Tensile Strength, SaF is Strain at Failure and WtF is Work to Failure.

FIG. 5 is a graph of stress (MPa) versus strain (%) for various anionic polymers (AP1-AP6) in combination with cationic polymer CP2. (b)-€ show tensile test parameters extrapolated from the tensile tests where, E is Young's Modulus, UTS is Ultimate Tensile Strength, SaF is Strain at Failure and WtF is Work to Failure.

FIG. 6 is a graph of stress (MPa) versus strain (%) for various anionic polymers (AP1 and AP10-AP13) in combination with cationic polymer CP2. b-e show tensile test parameters extrapolated from the tensile tests where, E is Young's Modulus, UTS is Ultimate Tensile Strength, SaF is Strain at Failure and WtF is Work to Failure.

FIG. 7 is a graph of stress (MPa) versus strain (%) for various anionic polymers (AP3, AP7-AP9 and AP11) in combination with cationic polymer CP2. b-e show tensile test parameters extrapolated from the tensile tests where, E is Young's Modulus, UTS is Ultimate Tensile Strength, SaF is Strain at Failure and WtF is Work to Failure.

FIG. 8 is a graph of stress (MPa) versus strain (%) for various polyelectrolyte systems.

FIG. 9 shows preliminary grease barrier experiments using AP1/CP2 exposed to olive oil and Italian dressing.

FIG. 10 shows preliminary experiments showing the recyclability of the films using concentrated saline solution (4 M KBr)

FIG. 11 shows preliminary debonding on demand experiments with AP1/CP2 where this system was used to glue PDMS sheets together and left overnight in saline solution to debond.

FIG. 12 shows AP1/CP2 being used to glue various substrates together.

FIG. 13 shows an example of the adhesive properties of AP11/CP2 with a salt concentration of 100 mM NaCl.

FIG. 14 shows the delamination of AP1/CP2 coating on an acrylic surface.

### DETAILED DESCRIPTION

Provided herein are cured products of a liquid complex coacervate, articles derived therefrom, and methods for the manufacture thereof. The present inventors have found that particular liquid complex coacervates can be useful for the preparation of ultra-stable coatings and other articles having tunable mechanical properties, providing articles useful for a variety of applications including, for example, packaging and labeling, protective coatings, sensing, water purification, tissue engineering, health care, wound dressings, drug delivery, and device manufacturing. Specifically, the present inventors have unexpectedly found that the identity of the charged groups, variation in charge density, and variation in polymer composition can affect the final mechanical properties of the resulting cured products.

Decreasing amounts of salt can be used to plasticize liquid coacervates and enable a transition from a processable liquid state to a solid product. The nature of coacervate-based materials, which can be aqueous-based, circumvents the need for purification or post-processing to remove organic solvents, while the strong electrostatic interactions driving the self-assembly of these materials can provide exceptionally stable and solvent resistant polyelectrolyte complexes.

The present inventors have found that the liquid-to-solid transition of aqueous complex coacervates can be controlled, for example, by adjusting polymer concentration, polymer chain length, identity of the charged groups, ionic strength, and solution pH. Such parameters can provide final polymer materials with variable mechanical properties, which can be selected to suit a particular application.

Accordingly, an aspect of the present disclosure is a cured product of a liquid complex coacervate. The liquid complex coacervate comprises a macroion phase comprising a polyanion, a polycation, and a salt. In an aspect, the liquid complex coacervate can be formed as an aqueous suspension comprising the macroion phase and an aqueous phase. The liquid complex coacervate can minimize or exclude organic solvents. For example, any organic solvent can be present in an amount of less than 5 weight percent, or less than 1 weight percent, or less than 0.1 weight percent, or can be excluded from the coacervate. In an aspect, no crosslinking agents are present in the liquid complex coacervate.

The polyanion of the liquid complex coacervate can be a synthetic polyanion or a naturally occurring anionic polyelectrolyte. In an aspect, the polyanion is a synthetic polyanion.

The polyanion comprises repeating units comprising one or more of a carboxylate group, a sulfonate group, a phosphonate group, a sulfate group, or a phosphate group. In an aspect, the polyanion can preferably be a synthetic polymer. For example, the polyanion can comprise repeating units derived from a polymerizable group and the carboxylate group, the sulfonate group, or the phosphonate group. The polymerizable group can comprise, for example, an ethylenically unsaturated group. In an aspect, the polyanion can comprise repeating units derived from a monomer having a (meth)acrylate group or a (meth)acrylamide group and the carboxylate group, the sulfonate group, or the phosphonate group. Suitable synthetic polyanions can be prepared, for example, by radical polymerization techniques. Methods of making polyanions are further described in the working examples below.

In an aspect, the polyanion can be a synthetic polyanion comprising repeating units of one or more of formulas (I)—(IV)

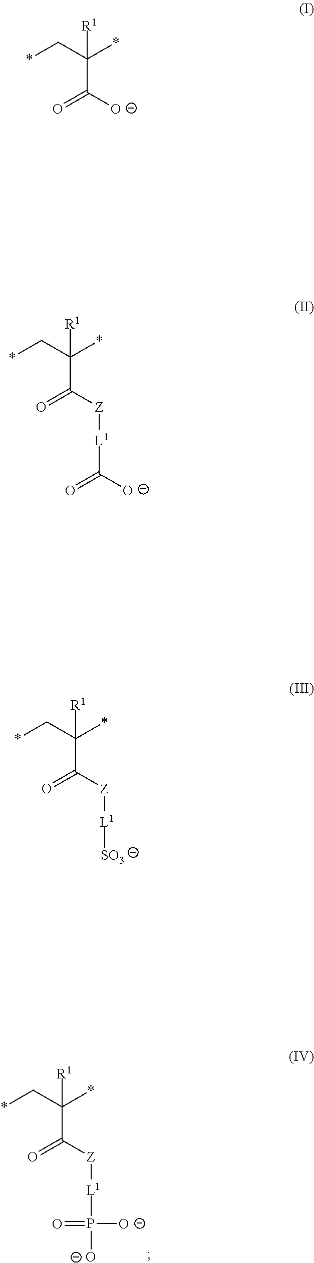

wherein in the foregoing Formulas, R¹ is H or methyl; L¹ is a divalent linking group; and Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group, preferably a C₁₋₆ alkyl group. In an aspect, the divalent linking group L¹ can be, for example, a substituted or unsubstituted C₁₋₁₂ alkylene group, a substituted or unsubstituted C₃₋₁₂ cycloalkylene group, a substituted or unsubstituted C₆₋₂₀ arylene group, a divalent C₁₋₂₀ alkylene oxide group, or a divalent poly(C₁₋₆ alkylene oxide) group. Preferably, L¹ can be a substituted or unsubstituted C₁₋₁₂ alkylene group, a substituted or unsubstituted C₃₋₁₂ cycloalkylene group, a substituted or unsubstituted C₆₋₂₀ arylene group, more preferably a C₁₋₁₂ alkylene group, even more preferably a C₁₋₆ alkylene group. In an aspect, when Z is —NR—, R can preferably be a C₁₋₆ alkyl group, preferably a methyl group, an ethyl group, a propyl group, an isopropyl group, or the like. In an aspect, Z is —O— or —NH—.

In an aspect, the polyanion can comprise repeating units according to formulas (I) or (III). In a specific aspect, the polyanion can comprise repeating units according to formulas (I) or (III) wherein R¹ is methyl, Z is —O—, and L¹ is a C₁₋₆ alkylene group.

The polyanion can have from 10 to 100 mole percent, or 10 to 90 mole percent, or 10 to 80 mole percent, or 10 to 70 mole percent, or 10 to 60 mole percent, or 10 to 50 mole percent or 10 to 40 mole percent, or 10 to 30 mole percent, or 10 to 75 mole percent, or 20 to 90 mole percent, or 30 to 90 mole percent, or 40 to 90 mole percent, or 50 to 90 mole percent of anionic groups. The number of anionic groups present in the polyanion is understood to determine the charge density of the polyanion.

The polyanion can optionally further comprise repeating units derived from a neutral hydrophilic monomer, repeating units derived from a neutral hydrophobic monomer, or a combination thereof. When one or more of the foregoing comonomers are present, the polyanion is preferably a random copolymer.

For example, repeating units derived from a neutral hydrophilic monomer can comprise a polymerizable group (e.g., containing ethylenic unsaturation) and a hydrophilic group. In an aspect, the repeating units derived from a neutral hydrophilic monomer can be of formula (VI)

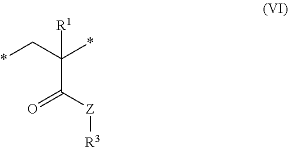

wherein R¹ is independently at each occurrence H or methyl; Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group, preferably a C₁₋₆ alkyl group, more preferably methyl or ethyl; and R³ is a hydroxy-substituted C₁₋₆ alkyl group (e.g., a hydroxyethyl group or a hydroxy propyl group), an oligo(C₁₋₆ oxyalkylene) group, a poly(C₁₋₆ oxyalkylene) group, or —NH₂. As used herein, the term “oligo” refers to oligomers having 2 to 10 repeating units (e.g., 2 to 10 C₁₋₆ oxyalkylene units). As used herein, the term “poly” refers to a polymer having greater than 10 repeating units (e.g., greater than 10 C₁₋₆ oxyalkylene units). In an aspect, Z is independently at each occurrence —O— or —NH—.

Repeating units derived from a neutral hydrophobic monomer can comprise a polymerizable group (e.g., containing ethylenic unsaturation) and a hydrophobic group. In an aspect, the repeating units derived from a neutral hydrophobic monomer can be of formula (VII)

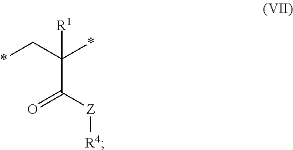

wherein R is independently at each occurrence H or methyl; Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group, preferably a C₁₋₆ alkyl group, more preferably methyl or ethyl; and R⁴ is a substituted or unsubstituted C₁₋₂₀ alkyl group, a substituted or unsubstituted C₃₋₁₂ cycloalkyl group, a substituted or unsubstituted C₆₋₂₀ aryl group. In an aspect, R⁴ can be a substituted or unsubstituted C₁₋₁₂ alkyl group, for example a C₁₋₆ alkyl group. In an aspect, Z is independently at each occurrence —O— or —NH—.

In an aspect, the polyanion can comprise repeating units according to formulas (I), (VI) and (VII). The repeating units of formulas (I), (VI) and (VII) can be present in a molar ratio of (I):(VI):(VII) of 10-100:0-90:0-90, or 20-100:0-80:0:80, or 50-100:0-50:0-50.

In an aspect, the polyanion can comprise repeating units according to formulas (III), (VI) and (VII). The repeating units of formulas (III), (VI) and (VII) can be present in a molar ratio of (III), (VI) and (VII) of 10-100:0-90:0-90, or 20-100:0-80:0:80, or 50-100:0-50:0-50. In an aspect, the polyanion can comprise 10 to 90 mole percent of a neutral hydrophilic comonomer, 5 to 50 mole percent of a neutral hydrophobic comonomer, with the balance being a monomer comprising an anionic group (e.g., a carboxylate).

In an aspect, the polyanion can comprise repeating units (meth)acrylic acid, 2-acrylamido-2-methyl-1-propanesulfonic acid, styrene sulfonate, sulfopropyl methacrylate, and the like or a combination thereof.

In addition to the polyanion, the liquid complex coacervate includes a polycation. The polycation can be a synthetic cationic polyelectrolyte or a naturally occurring cationic polyelectrolyte. In an aspect, the polycation is a synthetic polymer.

The polycation comprises repeating units comprising one or more of a nitrogen-containing cationic group, a phosphorus-containing cationic group, or a sulfur-containing cationic group. In an aspect, the polycation can preferably be a synthetic polymer. For example, the polycation can comprise repeating units derived from a polymerizable group and the nitrogen-containing cationic group, the phosphorus-containing cationic group, or the sulfur-containing cationic group. The polymerizable group can comprise, for example, an ethylenically unsaturated group. In an aspect, the polycation can comprise repeating units derived from a monomer having a (meth)acrylate group or a (meth)acrylamide group and the nitrogen-containing cationic group, the phosphorus-containing cationic group, or the sulfur-containing cationic group. As used herein, the term “nitrogen-containing cationic group” refers to any cationic group which includes nitrogen bearing a positive charge. For example, the nitrogen-containing cationic group can include ammonium, pyrrolium, imidazolium, pyrazolium, oxazolium, thiazolium, pyridinium, pyrimidinium, pyrazinium, pyridazinium, thiazinium, morpholinium, piperidinium, piperazinium, and pyrrolizinium. In an aspect, the nitrogen-containing cationic group is an ammonium group. As used herein, the term “phosphorus-containing cationic group” refers to a group containing a phosphorus-based cation, for example, triphenyl phosphonium, trimethyl phosphonium, triethyl phosphonium, tripropyl phosphonium, tributyl phosphonium, trichloro phosphonium, and trifluoro phosphonium and the like. As used herein, the term “sulfur-containing cationic group” refers to a group containing a sulfur-based cation, for example, a sulfonium group.

Suitable synthetic polycations can be prepared, for example, by radical polymerization techniques. Methods of making polycations are further described in the working examples below.

In an aspect, the polycation comprises a nitrogen-containing cation and can be of the formula

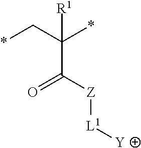

wherein R¹ is H or methyl; L¹ is a divalent linking group; Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group, preferably a C₁₋₆ alkyl group, more preferably methyl or ethyl; and Y is a nitrogen-containing group selected from ammonium, pyrrolium, imidazolium, pyrazolium, oxazolium, thiazolium, pyridinium, pyrimidinium, pyrazinium, pyridazinium, thiazinium, morpholinium, piperidinium, piperazinium, and pyrrolizinium. In an aspect, the divalent linking group L¹ can be, for example, a substituted or unsubstituted C₁₋₁₂ alkylene group, a substituted or unsubstituted C₃₋₁₂ cycloalkylene group, a substituted or unsubstituted C₆₋₂₀ arylene group, a divalent C₁₋₂₀ alkylene oxide group, or a divalent poly(C₁₋₆ alkylene oxide) group. Preferably, L¹ can be a substituted or unsubstituted C₁₋₁₂ alkylene group, a substituted or unsubstituted C₃₋₁₂ cycloalkylene group, a substituted or unsubstituted C₆₋₂₀ arylene group, more preferably a C₁₋₁₂ alkylene group, even more preferably a C₁₋₆ alkylene group. In an aspect, when Z is —NR—, R can preferably be a C₁₋₆ alkyl group, preferably a methyl group, an ethyl group, a propyl group, an isopropyl group, or the like. In an aspect, Z is —O— or —NH—.

In an aspect, the polycation comprises an ammonium group. For example, the polycation can comprise repeating units according to formula (V)

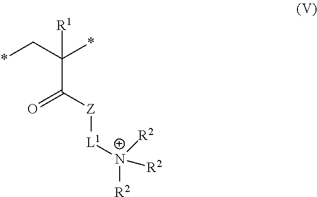

wherein R¹ is H or methyl; L¹ is a divalent linking group; Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group, preferably a C₁₋₆ alkyl group, more preferably methyl or ethyl; and R² is independently at each occurrence a substituted or unsubstituted C₁₋₂₀ alkyl group, preferably wherein each occurrence of R² is a methyl group. In an aspect, the divalent linking group L¹ can be, for example, a substituted or unsubstituted C₁₋₁₂ alkylene group, a substituted or unsubstituted C₃₋₁₂ cycloalkylene group, a substituted or unsubstituted C₆₋₂₀ arylene group, a divalent C₁₋₂₀ alkylene oxide group, or a divalent poly(C₁₋₆ alkylene oxide) group. Preferably, L¹ can be a substituted or unsubstituted C₁₋₁₂ alkylene group, a substituted or unsubstituted C₃₋₁₂ cycloalkylene group, a substituted or unsubstituted C₆₋₂₀ arylene group, more preferably a C₁₋₁₂ alkylene group, even more preferably a C₁₋₆ alkylene group. In an aspect, when Z is —NR—, R can preferably be a C₁₋₆ alkyl group, preferably a methyl group, an ethyl group, a propyl group, an isopropyl group, or the like. In an aspect, Z is —O— or —NH—.

The polycation can have from 10 to 100 mole percent, or 10 to 90 mole percent, or 10 to 80 mole percent, or 10 to 70 mole percent, or 10 to 60 mole percent, or 10 to 50 mole percent or 10 to 40 mole percent, or 10 to 30 mole percent, or 10 to 75 mole percent, or 20 to 90 mole percent, or 30 to 90 mole percent, or 40 to 90 mole percent, or 50 to 90 mole percent of cationic groups. The number of cationic groups present in the polyanion is understood to determine the charge density of the polycation.

The polycation can optionally further comprise repeating units derived from a neutral hydrophilic monomer, repeating units derived from a neutral hydrophobic monomer, or a combination thereof. When one or more of the foregoing comonomers are present, the polycation is preferably a random copolymer. Suitable hydrophilic and hydrophobic comonomers can be as described above for the polyanion.

In a specific aspect, the polycation can comprise repeating units according to formulas (V), (VI) and (VII). In an aspect, the repeating units of formulas (V), (VI) and (VII) can be present in a molar ratio of (V):(VI):(VII) of 50-100:0-50:0-50, or 50-85:15:50:0-35.

In an aspect, the polycation can comprise repeating units derived from dimethyldiallyl ammonium chloride, methacrylatoethyltrimethyl ammonium chloride, trimethyl aminoethyl methacrylate, allylamine hydrochloride, [2-(acryloyloxy)ethyl]trimethylammonium), and the like or a combination thereof.

In an aspect, one or both of the polyanion and the polycation can be a naturally occurring polyelectrolyte, or a synthetically modified derivative of a naturally occurring polyelectrolyte. Exemplary naturally occurring polyelectrolytes can include, for example, proteins, peptide, enzymes, DNA, RNA, glycosaminoglycans (e.g., heparin, hyaluronate, chondroitin sulfate), alginic acid, chitosan, chitosan sulfate, cellulose sulfate, polysaccharides, dextran sulfate, carrageenin, sulfonated lignin, carboxymethylcellulose and the like. In an aspect, the polyanion can comprise carboxymethyl cellulose or hyaluronic acid. In an aspect, the polycation can comprise chitosan.

In the liquid complex coacervate of the present disclosure, if the polycation is poly(diallyldimethyl ammonium), the polyanion is not polystyrene sulfonate. Alternatively, if the polyanion is polystyrene sulfonate, the polycation is not poly(diallyldimethyl ammonium). In an aspect, the nitrogen-containing cationic group is not derived from an amino acid, preferably lysine, histidine, or arginine. In an aspect, the cationic group is not a guanidinium group. In an aspect, one or both of the polyanion or the polycation is not biodegradable.

The polyanion and the polycation are combined to provide the liquid complex coacervate. For example, the polyanion and the polycation can be separately dissolved in an aqueous solution and the solutions can subsequently be combined to provide the liquid complex coacervate.

In an aspect, the stoichiometry of the polyanion to polycation in the liquid complex coacervate can be, for example, 3:7 to 7:3, or 3:6 to 6:3, or 3:5 to 5:3, or 3:4 to 4:3, or 1:2 to 2:1, or 1.5:1 to 1:1.5, or 1.1:1 to 1:1.1, or 1:1. In an aspect, the stoichiometry of the polyanion to polycation in the liquid complex coacervate can be, for example, 0.25 to 0.75, or 0.35 to 0.75, or 0.50 to 0.75, or 0.60 to 0.75, or 0.25 to 0.60, or 0.25 to 0.50, or 0.25 to 0.40, or 0.35 to 0.65, or 0.4 to 0.6.

The liquid complex coacervate further comprises a salt. The salt is not particularly limited and can comprise an alkali metal salt, a transition metal salt, a lanthanide metal salt, an actinide metal salt, a volatile salt, and the like or a combination thereof. For example, the salt can comprise NaCl, KCl, LiCl, NaBr, KBr, LiBr, NaI, KI, LiI, Na₂SO₄, NaNO₃, CaCl₂), MgCl₂, MgSO₄, ammonium formate, transition metal salts, lanthanides, actinides, and the like, or combinations thereof. A volatile salt can be preferred as removal from the coacervate can be effected by evaporation. Exemplary volatile salts can include, but are not limited to, ammonium carbonate, ammonium bicarbonate, ammonium acetate, ammonium formate, ammonium hydroxide, and the like, or combinations thereof.

The salt can be present in the liquid complex coacervate in an amount of 0 to 5 M. In an aspect, salt can be present in the cured product in an amount of 0 to 5 M. Within this range, the salt can be present in an amount of at most 4 M, or at most 3 M, or at most 2 M, or at most 1 M, or at most 0.5 M, or at most 0.1 M, or at most 0.01 M. Also within this range, the salt can be present in an amount of at least 0.001 M, or at least 0.01 M, or at least 0.1 M, or at least 1 M, or at least 2 M. In an aspect, no salt is present in the cured product.

The liquid complex coacervate can comprise an aqueous solvent (e.g., water) in an amount of 50 to 90 weight percent, based on the total weight of the liquid complex coacervate.

In an aspect, the liquid complex coacervate can optionally further comprise an additive, with the proviso that the additive does not significantly adversely affect the desired properties of the corresponding cured products. Exemplary additives can include but are not limited to dyes, pigments, nanoparticles, fillers, or combinations thereof.

In an aspect, the polyanion and the polycation can be substantially equal in length. In an aspect, the polyanion and the polycation can be of different lengths.

The liquid complex coacervates are cured to provide the corresponding cured products. As used herein, the term “cured” is used to refer to the transition of the liquid complex coacervate to a solid complex coacervate. Thus, the cured product is a solid material, for example comprising less than 50 percent by weight of a solvent, for example an aqueous solvent (e.g., water), for example, less than 40 percent by weight, or less than 30 percent by weight, or less than 25 percent by weight, or less than 20 percent by weight, or less than 10 percent by weight, or less than 5 percent by weight, or less than 1 percent by weight. The polyanion and the polycation of the liquid complex coacervate and the cured product are fully intermixed on a molecular level. Thus the cured product comprises the polyanion and the polycation substantially homogenously distributed throughout the cured product. The intermixed polyanion and polycation are present together in the same layer of the cured product. The cured product can therefore be referred to as a monolayer product, and thus is distinct from multilayered products comprising alternating layers of polyanions and polycations. In an aspect, the cured product can be substantially nonporous. For example, the cured product can have a porosity of less than 10 volume percent, or less than 5 volume percent, or less than 1 volume percent. In an aspect, when present, any pores can have an average diameter of less than 100 nanometers, or less than 90 nanometers.

In an aspect, the cured product can be in the form of a film, a coating, a fiber, or the like. In an aspect, the cured product can be in the form of a film or a coating that is freestanding or is disposed on at least a portion of a surface of a substrate or other article. An article comprising the cured product therefore represents another aspect of the present disclosure. The article can be a film, coating, fiber, or the like. In an aspect, the cured product can be disposed on at least a portion of a surface of the article. When the cured product is disposed on a substrate, the substrate can comprise paper, plastic, fabric, metal, cardboard, wood, concrete, glass, and the like or a combination thereof.

A method of forming the cured product represents another aspect of the present disclosure. The method comprises combining the polyanion, the polycation and the salt to provide the liquid complex coacervate. In an aspect, a solution comprising the polyanion and the polycation can be prepared. In an aspect, a precursor system can be provided wherein separate solutions (e.g., aqueous solutions) of the polyanion and the polycation can be provided. Salt can be added to the at least one of the solution of the polyanion or the polycation. In an aspect, the liquid complex coacervate can be prepared by combining the components of the precursor system (e.g., the polyanion solution and the polycation solution) to provide a liquid complex coacervate suspension. The dense liquid complex coacervate phase can be separated from the suspension. The liquid complex coacervate can be cured to provide the cured product. Curing can comprise exposing the liquid complex coacervate to conditions effective to remove at least a portion of the aqueous solvent. In an aspect, the liquid complex coacervate can be washed with water to remove at least a portion of the salt and solidify the complex coacervate. In an aspect, for example when a volatile salt is used, the liquid complex coacervate can be exposed to a temperature and pressure effective to volatilize at least a portion of the salt and solidify the complex coacervate.

In an aspect, a method of forming a coating on a substrate is provided. The method comprises combining a polyanion, a polycation and a salt to provide a liquid complex coacervate. Providing the liquid complex coacervate can be as described above. The liquid complex coacervate can be deposited on at least a portion of a substrate. Depositing the liquid complex coacervate can be by any solution coating technique that is generally known, for example including, but not limited to spin coating, solvent casting, dip coating, drop casting, doctor blading, ink jetting, painting, wiping, spray coating, and the like. Once deposited on the substrate, the liquid complex coacervate can be cured to provide the coating. Curing the liquid complex coacervate can be as described above.

The methods disclosed herein are further described in the working examples below.

Coatings or films prepared according to the method described herein can have a substantially uniform thickness. In some aspects, the thickness of the coating or the film can be 5 nanometers to 500 micrometers. Within this range, the thickness can be 10 nanometers to 500 micrometers, or 100 nanometers to 500 micrometers, or 1 micrometer to 500 micrometers, or 10 micrometers to 500 micrometers, or 100 micrometers to 500 micrometers, or 5 nanometers to 100 micrometers, or 5 nanometers to 10 micrometers, or 5 nanometers to 1 micrometer, or 5 nanometers to 500 nanometers, or 5 nanometers to 100 nanometers, or 10 nanometers to 1 micrometer, or 10 nanometers to 500 nanometers, or 10 nanometers to 200 nanometers or 20 nanometers to 100 nanometers.

The present inventors have surprisingly discovered that the mechanical properties of the cured products described herein can be tuned by adjusting various parameters.

In an aspect, the cured product comprises the salt and the tensile strain at break can be increased by at least 10% or at least 20% or at least 50% or at least 100% relative to an identical cured product not comprising the salt.

In aspect, the polyanion can comprise at least 10% of a neutral hydrophilic comonomer, and the tensile strain at break of the cured product can be increased by at least 10% or at least 20% or at least 50% or at least 100% relative to a cured product prepared from the same polycation and a polyanion not including the neutral hydrophilic comonomer.

In an aspect, the polyanion can comprise 15 to 40 mole percent of a neutral hydrophilic comonomer, 10 to 35 mole percent of a neutral hydrophobic comonomer, and the balance being a monomer comprising an anionic group (e.g., a carboxylate), and the tensile strain at break of the cured product can be increased by at least 10% or at least 20% or at least 50% or at least 100% relative to an identical cured product comprising a polyanion not including the neutral hydrophilic comonomer.

In an aspect, the polyanion can comprise a carboxylate anionic group, and the tensile strain at break of the cured product can be increased by at least 10% or at least 20% or at least 50% or at least 100% relative to a cured product comprising a polyanion comprising sulfonate anionic groups.

The cured products of the present disclosure are well suited for a variety of applications, in particular due to the tunability of the resulting mechanical properties. In aspect, the cured products can be useful as protective coatings, removable coatings, repositionable coatings, replaceable coatings, barrier coatings (e.g., as barriers for moisture, vapor, grease, oil, gas (e.g., oxygen), and the like), paper coatings (e.g., for improved smoothness or printability), water-proofing coatings, and anti-fouling coatings. In an aspect, the cured products can be useful as protective films. In an aspect, the liquid complex coacervates and the corresponding cured products can be useful as adhesive materials, for example pressure sensitive adhesives, laminating adhesives, adhesives for temporary mounting, and the like. In an aspect, debonding of an adhesive comprising the cured product can be achieved with exposure to a salt solution. In an aspect, the cured products can be useful for dental applications, for example as protective films provided by oral care products (e.g., protective barriers, mitigation of sensitivity, teeth whitening). In an aspect, the cured products can be useful in fiber bonding applications such as preparing recyclable materials out of fibers or shredded waste, fiber bonding for paper products, fiber bonding for textiles, and temporary fiber protective films. In an aspect, the cured products can be useful for a variety of medical application, for example tissue engineering, health care, wound dressings, and drug delivery. In an aspect, the liquid complex coacervates and cured products can be useful for inks. In an aspect, the cured products can be used as membranes, for example for separations. In an aspect, the cured products can be used as nail polish.

This disclosure is further illustrated by the following examples, which are non-limiting.

### Examples

The present examples utilize a model polymer system of poly(methacrylic acid) (PMAA) and poly(trimethyl aminoethyl methacrylate) (PTMAEMA). The effects of polymer charge content and co-monomer chemistry on the phase behavior of the liquid complex coacervate and on the mechanical properties of the solid films prepared from the coacervates were examined. Methacrylamide (MA) was selected as an exemplary neutral, water-soluble, relatively high Tg co-monomer, and butyl methacrylate (BMA) was selected as an exemplary hydrophobic, lower Tg comonomer.

Anionic polymers used in the following examples are provided in Table 1. The polyanions were synthesized according to the following exemplary procedure. For example, copolymer AP6 was prepared by stirring isopropanol (300 grams) in a 2 L reactor under nitrogen atmosphere and heated to 80° C. A mixture of methacrylic acid (20.21 grams), methacrylamide (179.8 grams), isopropanol (300 grams) and distilled water (200 grams) was added over 2 hours. In parallel, tert-butyl peroxypivalate (2.67 grams, 75% in isododecane)) as the initiator was added within three hours. After 1 hour, a second batch of initiator solution of tert-butyl peroxypivalate (2.67 grams, 75% in isododecane) in isopropanol (17.33 grams) was added within 1 hour, followed by another 3 hour post-polymerization. Subsequently, the methacrylic acid was neutralized with sodium hydroxide. For this purpose, a mixture of sodium hydroxide (9.39 grams) was dissolved in distilled water (200 grams) and added with a dropping funnel within 15 minutes. Isopropanol/water was then distilled off azeotropically at a heating bath temperature of 120° C., and the remaining isopropanol was removed by water steam distillation.

TABLE 1

| | Monomer A | Monomer B | Monomer C | Ratio A:B:C [mol %] |
|---|---|---|---|---|
| AP1 | methacrylic acid | | | 100 |
| AP2 | methacrylic acid | methacrylamide | | 75:25 |
| AP3 | methacrylic acid | methacrylamide | | 50:50 |
| AP4 | methacrylic acid | methacrylamide | | 35:65 |
| AP5 | methacrylic acid | methacrylamide | | 20:80 |
| AP6 | methacrylic acid | methacrylamide | | 10:90 |
| AP7 | methacrylic acid | methacrylamide | n-butyl methacrylate | 50:40:10 |
| AP8 | methacrylic acid | methacrylamide | n-butyl methacrylate | 50:30:20 |
| AP9 | methacrylic acid | methacrylamide | n-butyl methacrylate | 50:15:35 |
| AP10 | methacrylic acid | | n-butyl methacrylate | 75:25 |
| AP11 | methacrylic acid | | n-butyl methacrylate | 50:50 |
| AP12 | methacrylic acid | | n-butyl methacrylate | 87.5:12.5 |
| AP13 | methacrylic acid | | n-butyl methacrylate | 62.5:32.5 |

Cationic polymers used in the following examples are described in Table 2. Cationic homopolymers were prepared according to the following procedure. For example, homopolymer CP2 was prepared by stirring distilled water (370 grams) in a 2 L reactor under nitrogen atmosphere and heated to 72° C. At 72° C., a mixture of methacrylatoethyl trimethyl ammonium chloride (168 grams, 80% in water) and distilled water (168 grams) was added in 2 hours, and an initiator solution of 2,2′-azobis(2-methylpropionamidine) dihydrochloride (2.7 grams) and distilled water (24.3 grams) was added in 2.5 hours. After 2 hours of post-polymerization, the poly-cation homopolymer was completed.

An exemplary copolymer synthesis is described below. For example, copolymer CP6 was prepared by stirring isopropanol (134.4 grams) and distilled water (127.7 grams) in a 2 L reactor under nitrogen atmosphere and heated to 72° C. At 72° C., a mixture of methacrylatoethyl trimethyl ammonium chloride (104.9 grams, 80% in water), methacrylamide (10.3 grams), n-butyl methacrylate (40.2 grams), isopropanol (117.7 grams) and distilled water (110 grams) was added in 2 hours. In parallel, an initiator mixture of 2,2′-azobis(2-methylpropionamidine) dihydrochloride (2.7 grams) and distilled water (24.3 grams) was added in 2.5 hours. After a post-polymerization of 2 hours, the isopropanol water mixture was distilled off azeotropically at a bath temperature of 120° C. The remaining isopropanol was later removed by steam distillation.

TABLE 2

| | | | | Ratio D:E:F |
|---|---|---|---|---|
| | Monomer D | Monomer E | Monomer F | [mol %] |
| CP1 | Dimethyldiallyl ammoniumchloride | | | 100 |
| CP2 | methacrylatoethyltrimethyl ammonium | | | 100 |
| | chloride | | | |
| CP3 | methacrylatoethyltrimethyl ammonium | methacrylamide | | 75:25 |
| | chloride | | | |
| CP4 | methacrylatoethyltrimethyl ammonium | methacrylamide | | 50:50 |
| | chloride | | | |
| CP5 | methacrylatoethyltrimethyl ammonium | methacrylamide | n-butyl methacrylate | 50:30:20 |
| | chloride | | | |
| CP6 | methacrylatoethyltrimethyl ammonium | methacrylamide | n-butyl methacrylate | 50:15:35 |
| | chloride | | | |
| CP7 | methacrylatoethyltrimethyl ammonium | | n-butyl methacrylate | 50:50 |
| | chloride | | | |

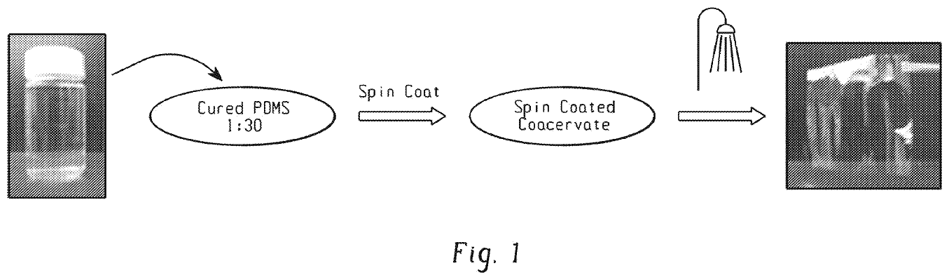

A schematic depiction of the procedure for processing liquid coacervates into films is shown in FIG. 1.

Coacervate samples were prepared by mixing the polyanion (e.g., PMAA) and the polycation (e.g., PTMAEMA) at a 1:1 stoichiometry on a charge basis to obtain the maximum amount of coacervate. The salt concentration of the samples (KBr) was modulated to alter the viscosity of the coacervate samples. Samples were equilibrated overnight before use.

Poly(dimethyl siloxane) (PDMS) with a 1:30 curing agent:monomer ratio was spin-coated and cured on a silicon wafer. Coacervate (3-5 mL) was then deposited onto the PDMS coated wafer and spin coated at 1000-3000 RPM for 60 seconds. Once the coacervate was spread evenly, it was either submerged in deionized water to remove salt from the polyelectrolyte complex (PEC) and solidify it, or it was allowed to air dry. The films were then cut into a dog-bone shape using a laser cutter for subsequent mechanical testing. Tensile testing was performed using a Differential Mechanical Analyzer to obtain stress-strain curves.

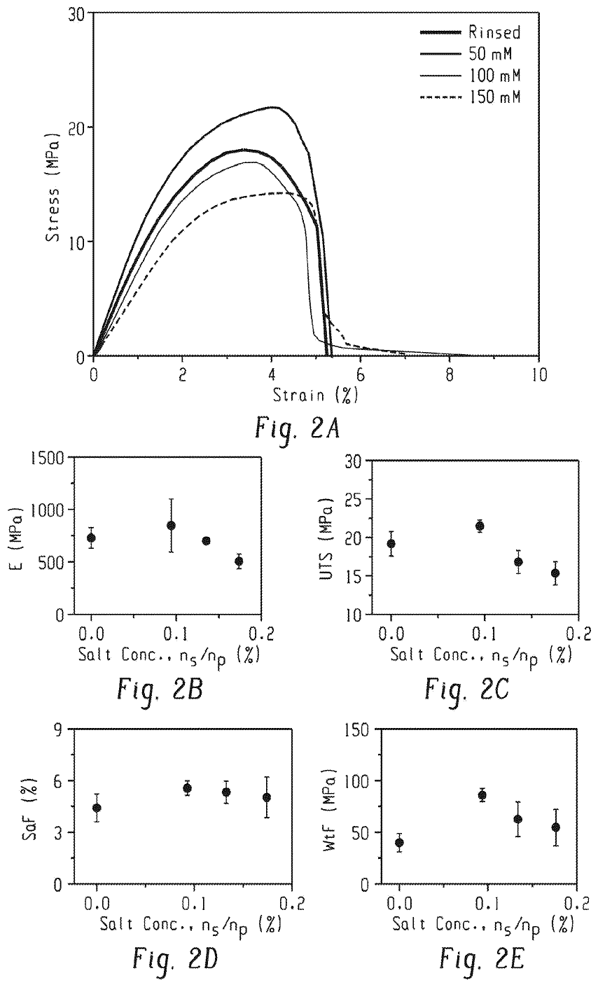

Stress-strain curves for PMAA-PTMAEMA films with no salt (solid black line) and without the rinsing step (50 mM KBr solid dark grey line, 100 mM KBr solid light grey line, 150 mM KBr dashed line) to remove the salt are shown in FIG. 2.

As shown in FIG. 2, it was observed that the presence of salt has a plasticizing effect on the films, increasing the toughness, the strain at break, the ultimate tensile stress, and the Young's modulus. This plasticization effect is consistent with PECs being “saloplastic” materials.

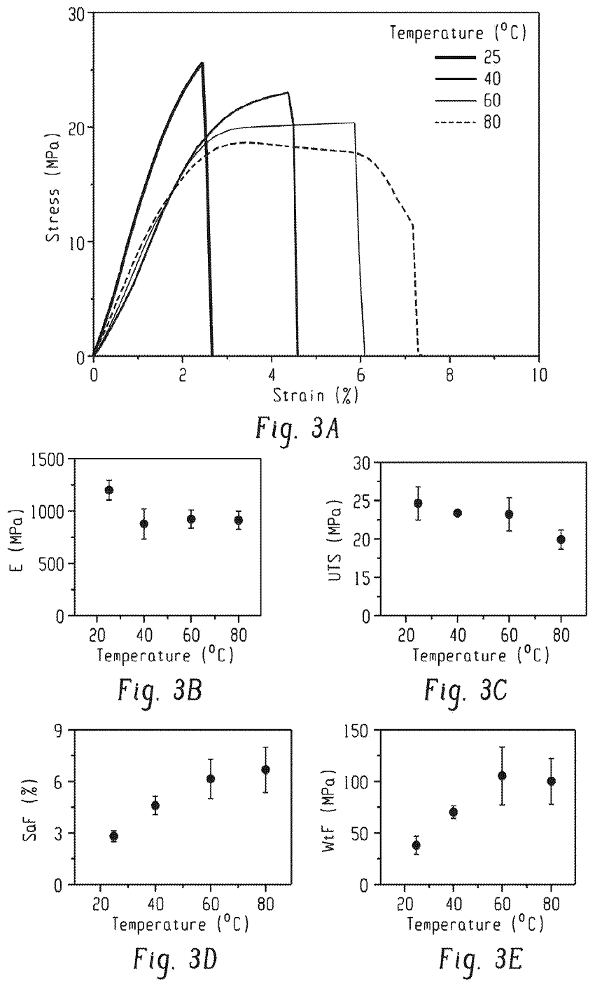

Stress-strain curves for PMAA-PTMAEMA films at different temperatures and constant relative humidity of 20% are shown in FIG. 3.

As shown in FIG. 3, it was observed that temperature relaxed the mechanics of the films, increasing the toughness and the strain at break, yet the ultimate tensile stress, and the Young's modulus was kept relatively constant. This is consistent with thermoplastic materials.

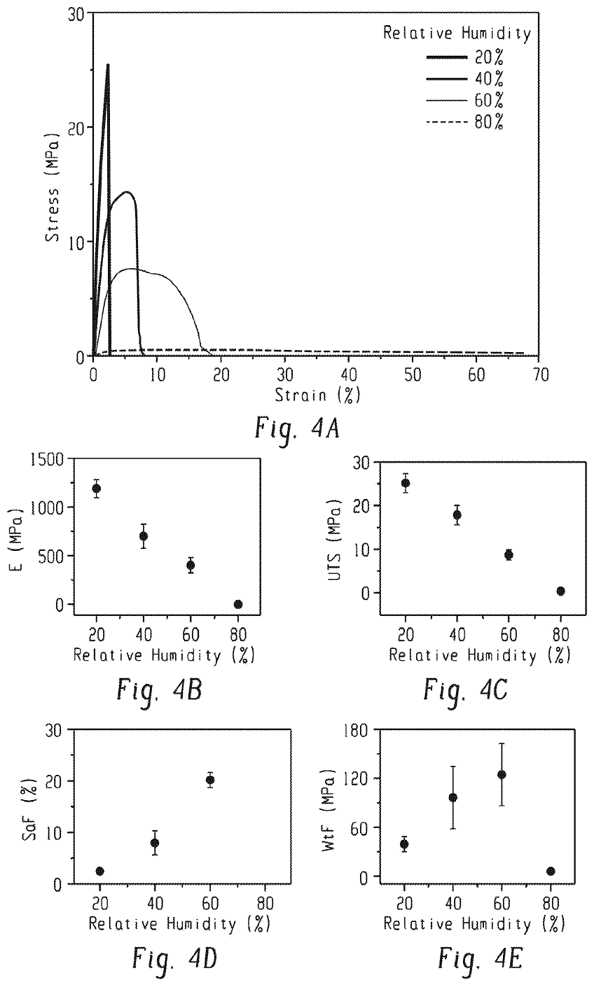

Stress-strain curves for PMAA-PTMAEMA films at different relative humidities and constant temperature of 25° C. are shown in FIG. 4.

As shown in FIG. 4, it was observed that relative humidity causes large changes in the stress-strain behavior of the films, more so than salt or temperature, increasing the toughness and the strain at break, but decreasing the ultimate tensile stress, and the Young's modulus with increased humidity. This dependency on relative humidity has been shown before by sugars (trehalose or raffinose), certain polymers (polyvinylpyrrolidone or Ficoll), penetrating cryoprotectants (ethylene glycol, propylene glycol, or dimethyl sulfoxide), and phosphate buffered saline (PBS) solutes.

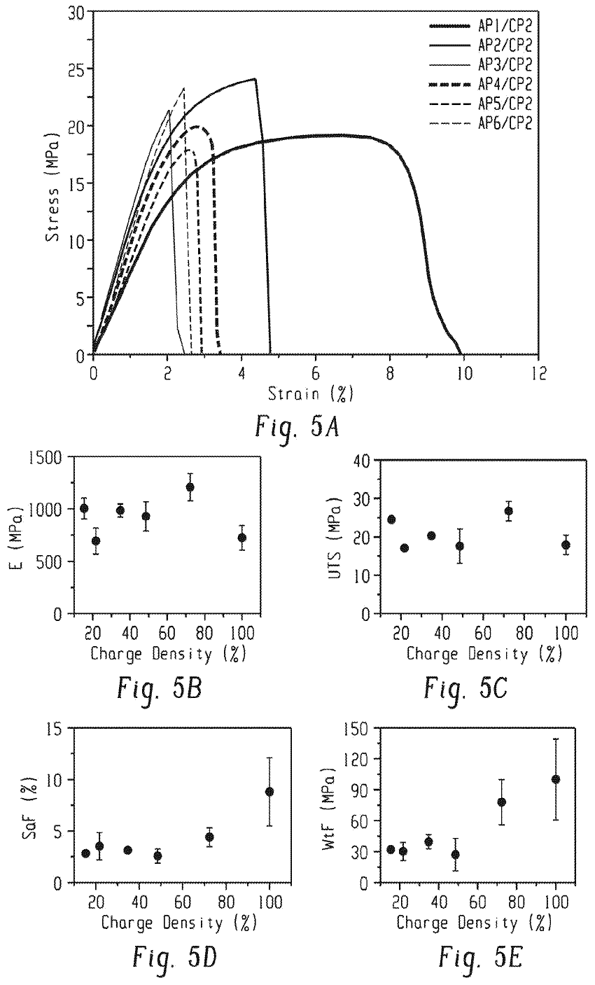

Variations in charge density were also explored. P(MAA-co-MA) was prepared with varying amount of MA comonomer. Increasing the amount of MA decreases the charge density of the P(MAA-co-MA) polyanion. The resulting stress-strain curves for P(MAA-co-MA) with PTMAEMA as the polycation are shown in FIG. 5. The samples shown in FIG. 5 refer to those from Table 1 and 2 above.

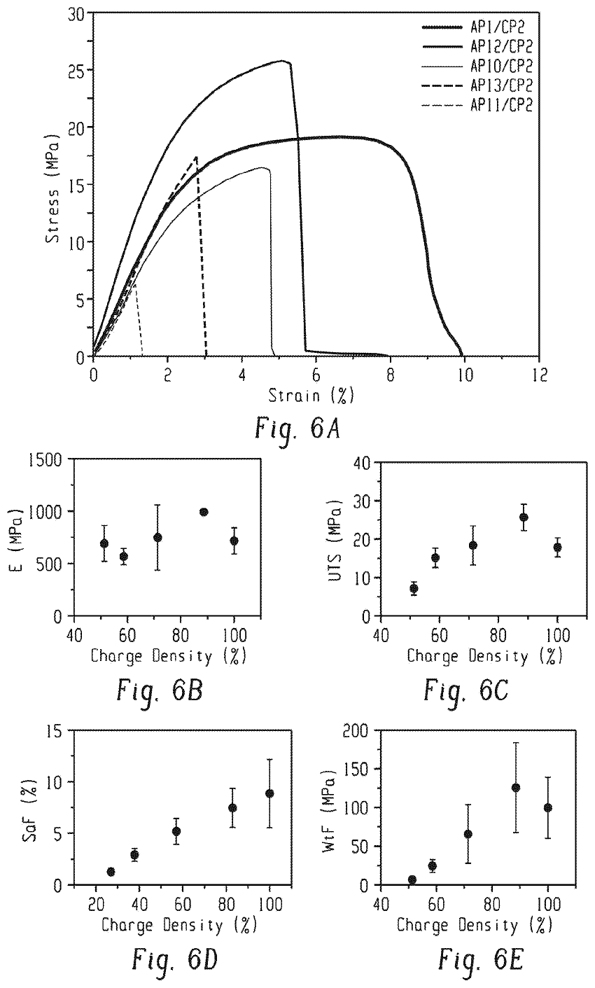

Similar variations in charge density were explored but with a hydrophobic monomer BMA. P(MAA-co-BMA) was prepared with varying amount of BMA comonomer. Increasing the amount of BMA decreases the charge density of the P(MAA-co-BMA) polyanion. The resulting stress-strain curves for P(MAA-co-MA) with PTMAEMA as the polycation are shown in FIG. 6. The samples shown in FIG. 6 refer to those from Table 1 and 2 above.

As shown in FIGS. 5 and 6, PECs made from polymers with a higher charge density show increasing ductility, as indicated by an increasing strain at break. When the charge density of the polyanion (PMAA) was decreased, the films were observed to be more brittle, exhibiting an increased ultimate tensile stress and Young's modulus, with decreasing overall toughness. The primary parameters that can be modified with charge density being strain at break and work to failure.

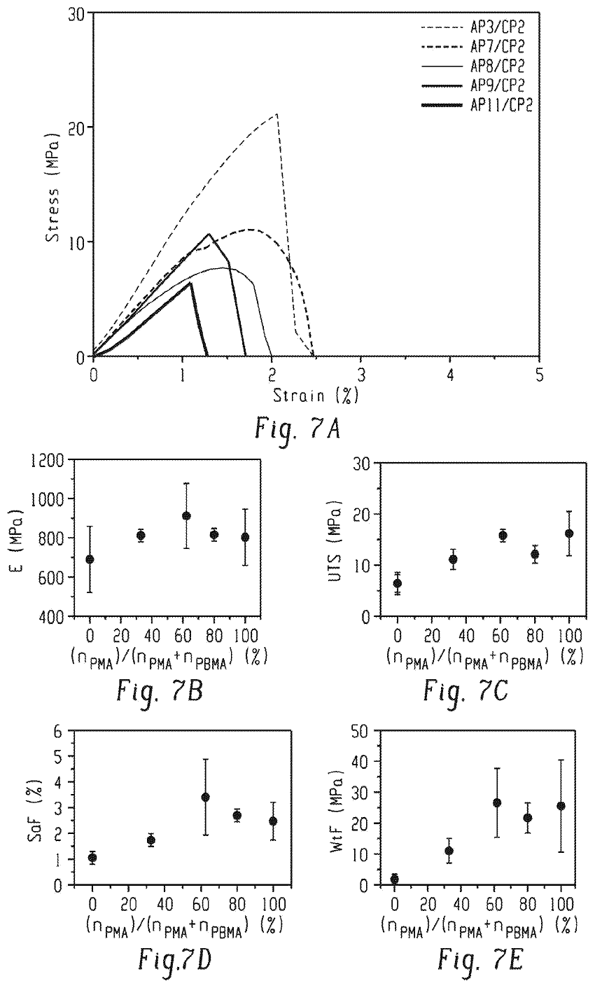

Copolymers of MAA, MA and BMA were also examined. In each copolymer, MAA was present in an amount of 50 mole percent. The remaining 50% was split between MA and BMA in the following molar ratios: 50:0, 40:10, 30:20, 15:35, 0:50. Coacervates were formed from the copolymers as the polyanion with PTMAEMA as the polycation. Stress-strain curves for these copolymers are shown in FIG. 7.

UTS, Young's modulus, and toughness were all observed to decrease as the materials increased in hydrophobicity (e.g., as the amount of a hydrophobic, low Tg comonomer increased). Without wishing to be bound by theory, little variation in the strain at break was observed across these samples, suggesting that it is the charge density of the PEC material, rather than the hydrophobicity (or high vs. low Tg) that dictates this property. Polymer concentration in the coacervate was observed to be proportional to Young's modulus and UTS, as shown in FIG. 6.

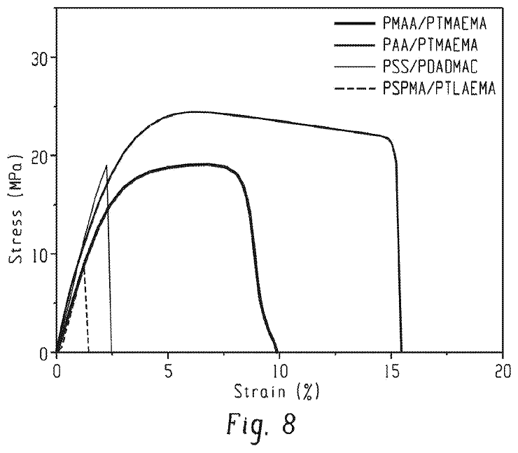

It was also observed that the ion identity can be used to tune the mechanical properties of the resulting films. PEC films tested were based on poly(styrene-sulfonate) and poly(diallyldimethylammonium chloride) (PSS/PDADMAC), poly(sulfopropyl methacrylate) and PTMAEMA (PSPMA/PTMAEMA), poly(acrylic acid) (PAA) and PTMAEMA and PMAA and PTMAEMA. A comparison of the stress-strain curves for each PEC sample tested is shown in FIG. 8.

As shown in FIG. 8, without wishing to be bound by theory, the chemistry of the polymers used, independent of their charge density, seems to play a big role in the mechanical properties of these materials. For example, PEC systems with sulfonate groups were observed to be more brittle, whereas PEC systems with carboxylate groups were observed to be tougher and more ductile.

Various proof of concept experiments were done to determine the usefulness of films made from PECs.

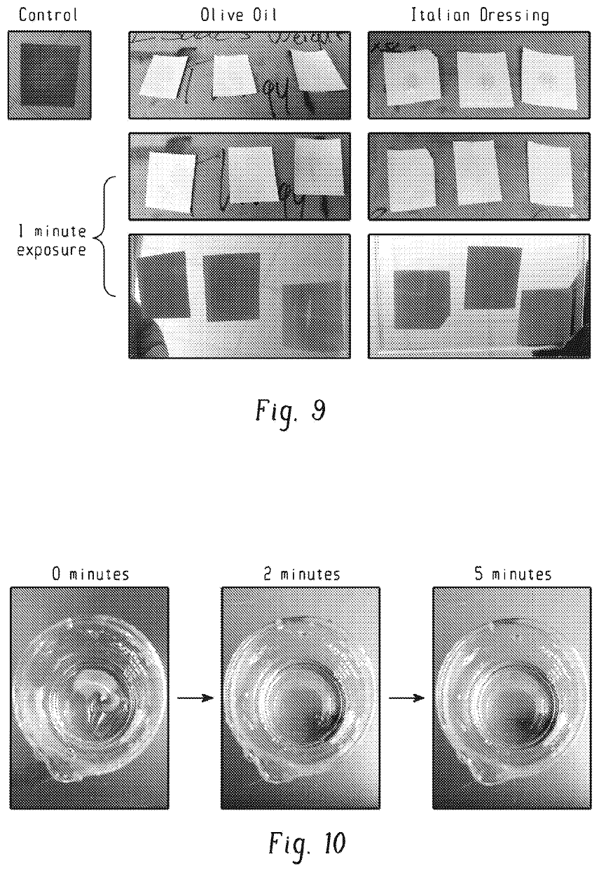

Their potential as grease barrier coatings are shown in FIG. 9. Where paperboard was coated in PEC made from PMAA/PTMAEMA and then soaked in olive oil and Italian dressing for one minute as is standard by the FDA. The coatings passed the grease barrier test when compared to the control sample that had much higher transparency than paperboard without PEC coating.

Their aqueous processability is shown in FIG. 10. A dried film can be dissolved in saline water and then be re-cast into different surfaces or processed into different shapes.

PECs can also be used as sacrificial layers, or for debonding on-demand. Their potential is showcased in FIG. 11 where two pieces of PDMS were adhered together by PMAA/PTMAEMA PECs. The debonding of two surfaces can be triggered by soaking in saline water and mixing.

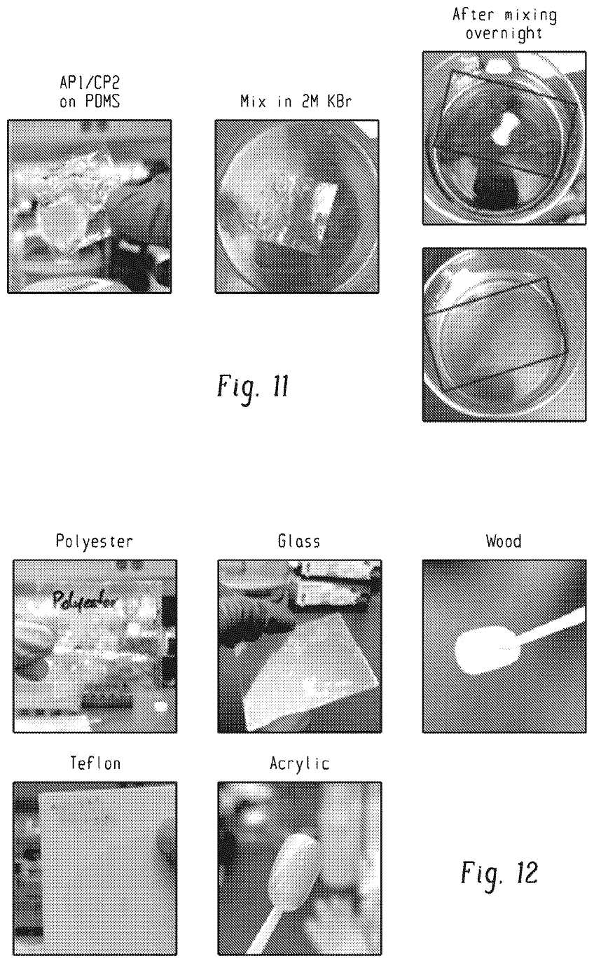

Their adhesive potential is shown in FIG. 12. Where PMAA/PTMAEMA PECs have shown highly adhesive forces to various substrates, including polyester, glass, polytetrafluoroethylene, acrylic and wood, on top of the aforementioned substrates (i.e. PDMS, paperboard).

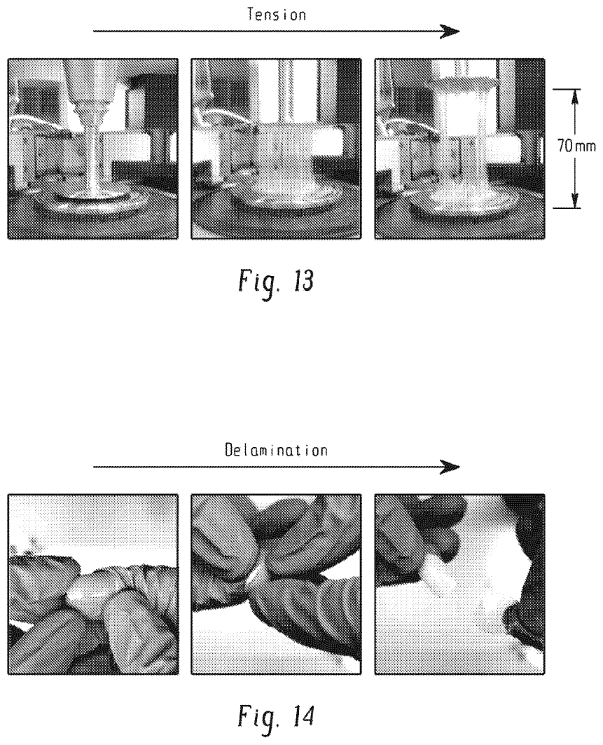

FIG. 13 shows their potential as hydrated adhesives. When hydrated or in humid environments, PECs show highly adhesive forces, consistent to their use as pressure sensitive adhesives.

FIG. 14 shows their delamination potential. Where one can take advantage of dry air or low humidity to delaminate the coating for the bounded substrate without damaging said substrate.

Accordingly, a significant improvement in polymer coacervate materials and coatings and articles derived therefrom is provided by the present disclosure.

This disclosure further encompasses the following aspects.

Aspect 1: A cured product of a liquid complex coacervate, wherein the liquid complex coacervate comprises a macroion phase comprising a polyanion, a polycation, and a salt; wherein the polyanion comprises repeating units comprising one or more of a carboxylate group, a sulfonate group, a phosphonate group, a sulfate group, or a phosphate group; and wherein the polycation comprises repeating units comprising one or more of a nitrogen-containing cationic group, a phosphorus-containing cationic group, or a sulfur-containing cationic group; provided that when the polycation is poly(diallyldimethyl ammonium), the polyanion is not polystyrene sulfonate, or when the polyanion is polystyrene sulfonate, the polycation is not poly(diallyldimethyl ammonium).

Aspect 2: The cured product of aspect 1, wherein the polyanion comprises repeating units derived from a monomer having a (meth)acrylate group or a (meth)acrylamide group and the carboxylate group, the sulfonate group, or the phosphonate group; and wherein the polycation comprises repeating units derived from a monomer having a (meth)acrylate group or a (meth)acrylamide group and the nitrogen-containing cationic group, the phosphorus-containing cationic group, or the sulfur-containing cationic group.

Aspect 3: The cured product of any of aspects 1 to 2, wherein the polyanion comprises repeating units of one or more of formulas (I)—(IV)

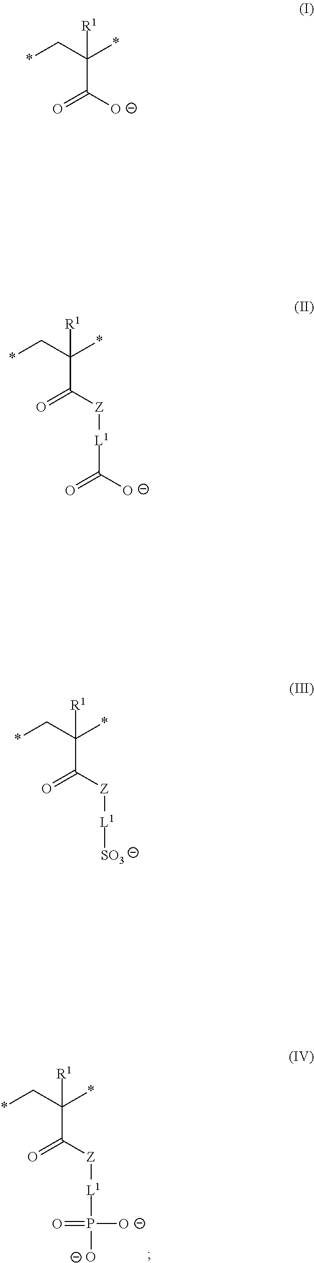

wherein in the foregoing Formulas, R¹ is H or methyl; L¹ is a divalent linking group, preferably wherein L¹ is a substituted or unsubstituted C₁₋₁₂ alkylene group, a substituted or unsubstituted C₃₋₁₂ cycloalkylene group, a substituted or unsubstituted C₆₋₂₀ arylene group, a divalent C₁₋₂₀ alkylene oxide group, or a divalent poly(C₁₋₆ alkylene oxide) group; and Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group, preferably a C₁₋₆ alkyl group, more preferably methyl or ethyl.

Aspect 4: The cured product of any of aspects 1 to 3, wherein the polycation comprises repeating units of formula (V)

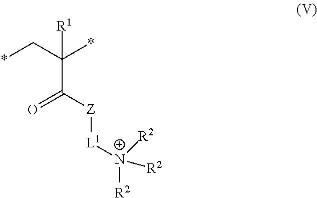

wherein R¹ is H or methyl; L¹ is a divalent linking group, preferably wherein L¹ is a substituted or unsubstituted C₁₋₁₂ alkylene group, a substituted or unsubstituted C₃₋₁₂ cycloalkylene group, a substituted or unsubstituted C₆₋₂₀ arylene group, a divalent C₁₋₂₀ alkylene oxide group, or a divalent poly(C₁₋₆ alkylene oxide) group; Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group, preferably a C₁₋₆ alkyl group, more preferably methyl or ethyl; and R² is independently at each occurrence a substituted or unsubstituted C₁₋₂₀ alkyl group, preferably wherein each occurrence of R² is a methyl group.

Aspect 5: The cured product of any of aspects 1 to 4, wherein the polyanion comprises repeating units of formula (I) or (III)

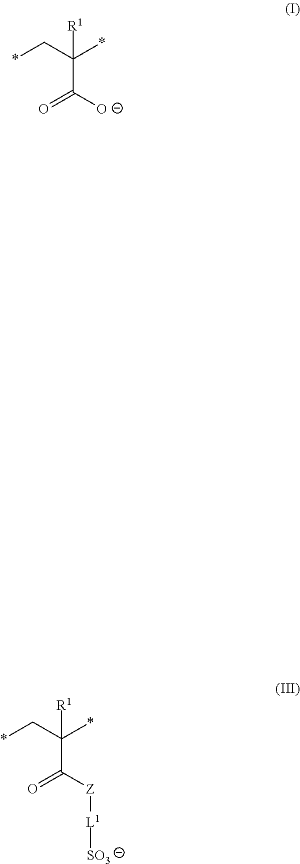

preferably, wherein R¹ is methyl, Z is —O—, and L¹ is a C₁₋₆ alkylene group.

Aspect 6: The cured product of any of aspects 1 to 5, wherein the polyanion, the polycation, or both further comprise repeating units derived from a neutral hydrophilic monomer, repeating units derived from a neutral hydrophobic comonomer, or a combination thereof.

Aspect 7: The cured product of aspect 6, wherein the repeating units derived from a neutral hydrophilic monomer are of formula (VI)

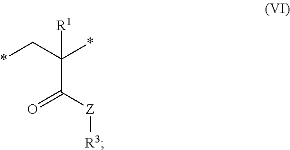

the repeating units derived from a neutral hydrophobic monomer are of formula (VII)

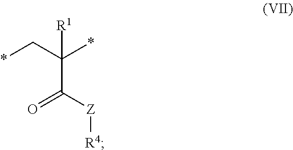

wherein in the forgoing formulas, R¹ is independently at each occurrence H or methyl; Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group, preferably a C₁₋₆ alkyl group, more preferably methyl or ethyl; R³ is a hydroxy-substituted C₁₋₆ alkyl group, an oligo(C₁₋₆ oxyalkylene) group, a poly(C₁₋₆ oxyalkylene) group, or —NH₂; and R⁴ is a substituted or unsubstituted C₁₋₂₀ alkyl group, a substituted or unsubstituted C₃₋₁₂ cycloalkyl group, a substituted or unsubstituted C₆₋₂₀ aryl group.

Aspect 8: The cured product of aspect 1, wherein the polyanion comprises repeating units according to formulas (I), (VI) and (VII), wherein the repeating units of formulas (I), (VI) and (VII) are present in a molar ratio of (I):(VI):(VII) of 10-100:0-90:0-90.

Aspect 9: The cured product of aspect 1, wherein the polyanion comprises repeating units according to formulas (III), (VI) and (VII), wherein the repeating units of formulas (III), (VI) and (VII) are present in a molar ratio of (III):(VI):(VII) of 10-100:0-90:0-90.

Aspect 10: The cured product of aspect 1, wherein the polycation comprises repeating units according to formulas (V), (VI) and (VII), wherein the repeating units of formulas (V), (VI) and (VII) are present in a molar ratio of (V):(VI):(VII) of 10-100:0-90:0-90.

Aspect 11: The cured product of any of aspects 1 to 10, wherein the salt comprises an alkali metal salt, a transition metal salt, a lanthanide metal salt, an actinide metal salt, a volatile salt, or a combination thereof.

Aspect 12: The cured product of any of aspects 1 to 11, wherein the cured product is in the form of a protective coating, a removable coating, a repositionable coating, a replaceable coating, a protective film.

Aspect 13: The cured product of any aspects 1 to 11 wherein the cured product is in the form of a barrier coating, a paper coating, a water-proof coating, or an antifouling coating.

Aspect 14: The cured product of any aspects 1 to 11 wherein the cured product is in the form of a pressure sensitive adhesive or a laminate adhesive.

Aspect 15: The cured product of any aspects 1 to 11 wherein the cured product is in the form of a protective film for oral care.

Aspect 16: The cured product of any aspects 1 to 11 wherein the cured product is in the form of an ink.

Aspect 17: The cured product of any aspects 1 to 11 wherein the cured product is in the form a membrane.

Aspect 18: The cured product of any aspects 1 to 11 wherein the cured product is in the form of a nail polish.

Aspect 19: An article comprising the cured product of any of aspects 1 to 18.

Aspect 20: The article of aspect 19, wherein the article is a film, coating, or fiber.

Aspect 21: The article of aspects 19 or 20, wherein the cured product is disposed on at least a portion of a surface of the article.

Aspect 22: A method of forming the cured product of any of claims 1 to 18, the method comprising: combining a polyanion, a polycation and a salt to provide a liquid complex coacervate; and curing the liquid complex coacervate to provide the cured product.

Aspect 23: A method of forming a coating on a substrate, the method comprising: combining a polyanion, a polycation and a salt to provide a liquid complex coacervate; depositing the liquid complex coacervate on at least a portion of the substrate; and curing the deposited liquid complex coacervate to provide the coating; wherein the polyanion comprises repeating units comprising one or more of a carboxylate group, a sulfonate group, or a phosphonate group; and wherein the polycation comprises repeating units comprising one or more of a nitrogen-containing cationic group, a phosphorus-containing cationic group, or a sulfur-containing cationic group, provided that when the polycation is poly(diallyldimethyl ammonium), the polyanion is not polystyrene sulfonate, or when the polyanion is polystyrene sulfonate, the polycation is not poly(diallyldimethyl ammonium).

Aspect 24: The method of claim 22 or 23, wherein the polyanion comprises repeating units of one or more of formulas (I)—(IV)

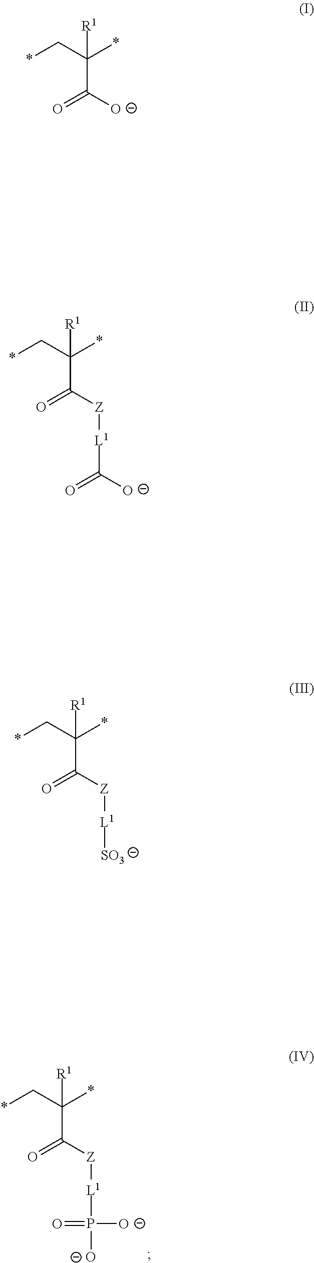

wherein in the foregoing Formulas, R¹ is H or methyl; L¹ is a divalent linking group, preferably wherein L¹ is a substituted or unsubstituted C₁₋₁₂ alkylene group, a substituted or unsubstituted C₃₋₁₂ cycloalkylene group, a substituted or unsubstituted C₆₋₂₀ arylene group, a divalent C₁₋₂₀ alkylene oxide group, or a divalent poly(C₁₋₆ alkylene oxide) group; and Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group, preferably a C₁₋₆ alkyl group, more preferably methyl or ethyl.

Aspect 25: The method of any of aspects 22 to 24, wherein the polycation comprises repeating units of formula (V)

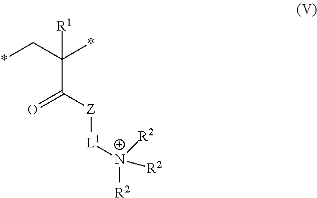

wherein R¹ is H or methyl; L¹ is a divalent linking group, preferably wherein L¹ is a substituted or unsubstituted C₁₋₁₂ alkylene group, a substituted or unsubstituted C₃₋₁₂ cycloalkylene group, a substituted or unsubstituted C₆₋₂₀ arylene group, a divalent C₁₋₂₀ alkylene oxide group, or a divalent poly(C₁₋₆ alkylene oxide) group; Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group, preferably a C₁₋₆ alkyl group, more preferably methyl or ethyl; and R² is independently at each occurrence a substituted or unsubstituted C₁₋₂₀ alkyl group, preferably wherein each occurrence of R² is a methyl group.

Aspect 26: The method of any of aspects 22 to 25, wherein the salt comprises an alkali metal salt, a transition metal salt, a lanthanide metal salt, an actinide metal salt, a volatile salt, or a combination thereof.

Aspect 27: The method of any of aspects 22 to 26, wherein curing the liquid complex coacervate comprises exposing the liquid complex coacervate to conditions effective to remove the salt.

Aspect 28: The method of aspect 27, wherein conditions effective to remove the salt comprise washing the liquid complex coacervate with water.

Aspect 29: The method of aspect 27, wherein conditions effective to remove the salt comprise exposing the deposited liquid complex coacervate to a temperature and pressure effective to volatilize the salt.

Aspect 30: A coating prepared by the method according to any of claims 22 to 29.

Aspect 31: A precursor system comprising a first component comprising a polyanion comprises repeating units comprising one or more of a carboxylate group, a sulfonate group, a phosphonate group, a sulfate group, or a phosphate group, and a second component comprising a polycation comprises repeating units comprising one or more of a nitrogen-containing cationic group, a phosphorus-containing cationic group, or a sulfur-containing cationic group; wherein at least one of the first component or the second component comprise a salt.

Aspect 32: The precursor system of aspect 31, wherein the polyanion comprises repeating units of one or more of formulas (I)—(IV)

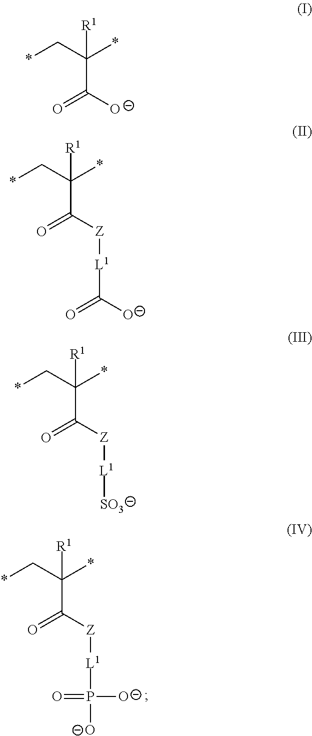

and wherein the polycation comprises repeating units of formula (V)

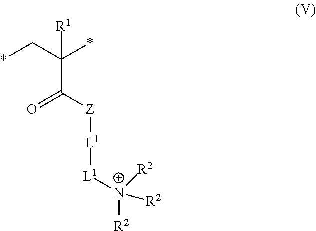

wherein in the foregoing Formulas, R¹ is H or methyl; R² is independently at each occurrence a substituted or unsubstituted C₁₋₂₀ alkyl group, preferably wherein each occurrence of R² is a methyl group; L¹ is a divalent linking group, preferably wherein L¹ is a substituted or unsubstituted C₁₋₁₂ alkylene group, a substituted or unsubstituted C₃₋₁₂ cycloalkylene group, a substituted or unsubstituted C₆₋₂₀ arylene group, a divalent C₁₋₂₀ alkylene oxide group, or a divalent poly(C₁₋₆ alkylene oxide) group; and Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group, preferably a C₁₋₆ alkyl group, more preferably methyl or ethyl.

Aspect 33: The precursor system of aspect 31 or 32, wherein the salt comprises an alkali metal salt, a transition metal salt, a lanthanide metal salt, an actinide metal salt, a volatile salt, or a combination thereof.

Aspect 34: A liquid complex coacervate product comprising a macroion phase comprising a polyanion, a polycation, and a salt; and optionally, a water-rich phase.

Aspect 35: The liquid complex coacervate product of aspect 34, wherein the polyanion comprises repeating units of one or more of formulas (I)—(IV)

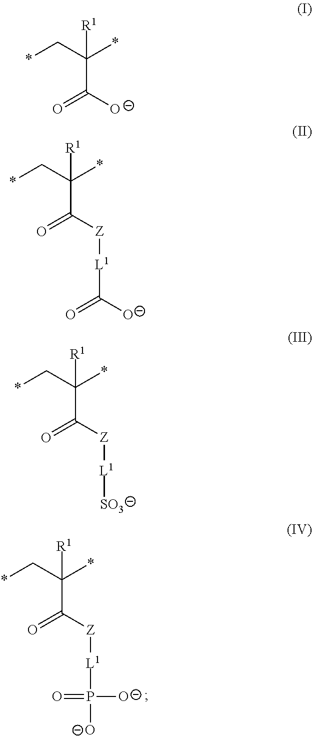

And wherein the polycation comprises repeating units of formula (V)

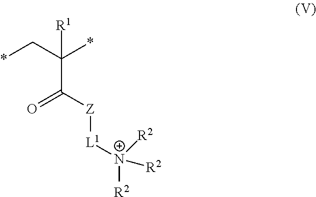

wherein in the foregoing Formulas, R¹ is H or methyl; R² is independently at each occurrence a substituted or unsubstituted C₁₋₂₀ alkyl group, preferably wherein each occurrence of R² is a methyl group; L¹ is a divalent linking group, preferably wherein L¹ is a substituted or unsubstituted C₁₋₁₂ alkylene group, a substituted or unsubstituted C₃₋₁₂ cycloalkylene group, a substituted or unsubstituted C₆₋₂₀ arylene group, a divalent C₁₋₂₀ alkylene oxide group, or a divalent poly(C₁₋₆ alkylene oxide) group; and Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group, preferably a C₁₋₆ alkyl group, more preferably methyl or ethyl.

Aspect 36: The liquid complex coacervate product of aspect 34 or 35, wherein the salt comprises an alkali metal salt, a transition metal salt, a lanthanide metal salt, an actinide metal salt, a volatile salt, or a combination thereof.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A cured product of a liquid complex coacervate, wherein the liquid complex coacervate comprises a macroion phase comprising a polyanion, a polycation, and a salt;
wherein the polyanion comprises repeating units comprising one or more of a carboxylate group, a sulfonate group, a phosphonate group, a sulfate group, or a phosphate group; and
wherein the polycation comprises repeating units comprising one or more of a nitrogen-containing cationic group, a phosphorus-containing cationic group, or a sulfur-containing cationic group;
provided that when the polycation is poly(diallyldimethyl ammonium), the polyanion is not polystyrene sulfonate, or when the polyanion is polystyrene sulfonate, the polycation is not poly(diallyldimethyl ammonium).

2. The cured product of claim 1,
wherein the polyanion comprises repeating units derived from a monomer having a (meth)acrylate group or a (meth)acrylamide group and the carboxylate group, the sulfonate group, or the phosphonate group; and
wherein the polycation comprises repeating units derived from a monomer having a (meth)acrylate group or a (meth)acrylamide group and the nitrogen-containing cationic group, the phosphorus-containing cationic group, or the sulfur-containing cationic group.

3. The cured product of claim 1,
wherein the polyanion comprises repeating units of one or more of formulas (I)—(IV) 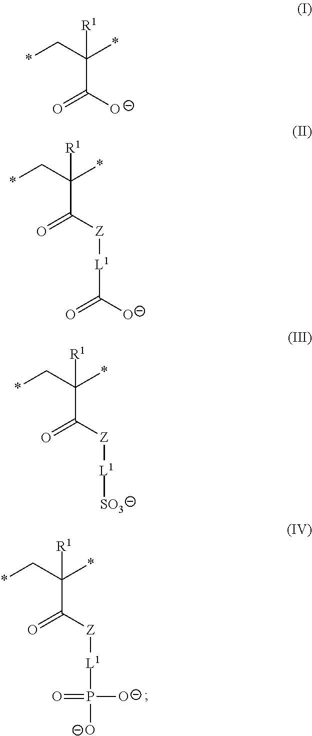
wherein in the foregoing Formulas,
R¹ is H or methyl;
L¹ is a divalent linking group; and
Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group; and
wherein the polycation comprises repeating units of formula (V) 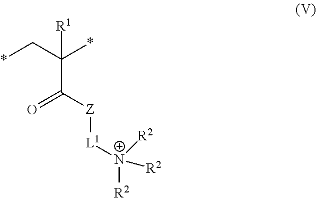
wherein
R¹ is H or methyl;
L¹ is a divalent linking group;
Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted C₆₋₂₀ aryl group, a C₁₋₂₀ alkylene oxide group, or a poly(C₁₋₆ alkylene oxide) group; and
R² is independently at each occurrence a substituted or unsubstituted C₁₋₂₀ alkyl group; and
wherein the salt comprises an alkali metal salt, a transition metal salt, a lanthanide metal salt, an actinide metal salt, a volatile salt, or a combination thereof.

4. (canceled)

5. The cured product of claim 1, wherein the polyanion comprises repeating units of formula (I) or (III) 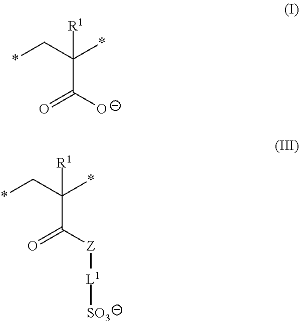
wherein R¹ is methyl, Z is —O—, and L¹ is a C₁₋₆ alkylene group.

6. The cured product of claim 1, wherein the polyanion, the polycation, or both further comprise repeating units derived from a neutral hydrophilic monomer, repeating units derived from a neutral hydrophobic comonomer, or a combination thereof;
wherein
the repeating units derived from a neutral hydrophilic monomer are of formula (VI) 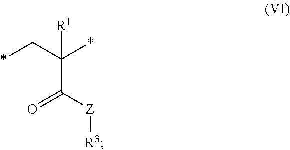
wherein in the forgoing formulas, 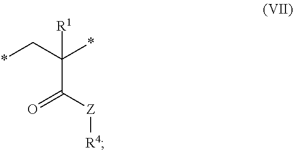
R¹ is independently at each occurrence H or methyl;
Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group;
R³ is hydroxy-substituted C₁₋₆ alkyl group, an oligo(C₁₋₆ oxyalkylene) group, a poly(C₁₋₆ oxyalkylene) group, or —NH₂; and
R⁴ is a substituted or unsubstituted C₁₋₂₀ alkyl group, a substituted or unsubstituted C₃₋₁₂ cycloalkyl group, a substituted or unsubstituted C₆₋₂₀ aryl group.

7. (canceled)

8. The cured product of claim 1, wherein
the polyanion comprises repeating units according to formulas (I), (VI) and (VII), wherein the repeating units of formulas (I), (VI) and (VII) are present in a molar ratio of (I):(VI):(VII) of 10-100:0-90:0-90; or
the polyanion comprises repeating units according to formulas (III), (VI) and (VII), wherein the repeating units of formulas (III), (VI) and (VII) are present in a molar ratio of (III):(VI):(VII) of 10-100:0-90:0-90; and
the polycation comprises repeating units according to formulas (V), (VI) and (VII), wherein the repeating units of formulas (V), (VI) and (VII) are present in a molar ratio of (V):(VI):(VII) of 10-100:0-90:0-90.

9. (canceled)

10. (canceled)

11. (canceled)

12. The cured product of claim 1, wherein the cured product is in the form of a protective coating, a removable coating, a repositionable coating, a replaceable coating, a barrier coating, a paper coating, a water-proof coating, an anti-fouling coating, a protective film, a pressure sensitive adhesive, a laminating adhesive, a protective film for oral care, an ink, a membrane, or nail polish.

13. An article comprising the cured product of claim 1, wherein the article is a film, coating, or fiber, or wherein the cured product is disposed on at least a portion of a surface of the article.

14. (canceled)

15. (canceled)

16. A method of forming the cured product of claim 1, the method comprising:
combining a polyanion, a polycation and a salt to provide a liquid complex coacervate; and
curing the liquid complex coacervate to provide the cured product.

17. A method of forming a coating on a substrate, the method comprising:
combining a polyanion, a polycation and a salt to provide a liquid complex coacervate;
depositing the liquid complex coacervate on at least a portion of the substrate; and
curing the deposited liquid complex coacervate to provide the coating;
wherein the polyanion comprises repeating units comprising one or more of a carboxylate group, a sulfonate group, or a phosphonate group; and
wherein the polycation comprises repeating units comprising one or more of a nitrogen-containing cationic group, a phosphorus-containing cationic group, or a sulfur-containing cationic group,
provided that when the polycation is poly(diallyldimethyl ammonium), the polyanion is not polystyrene sulfonate, or when the polyanion is polystyrene sulfonate, the polycation is not poly(diallyldimethyl ammonium).

18. The method of claim 17,
wherein the polyanion comprises repeating units of one or more of formulas (I)—(IV) 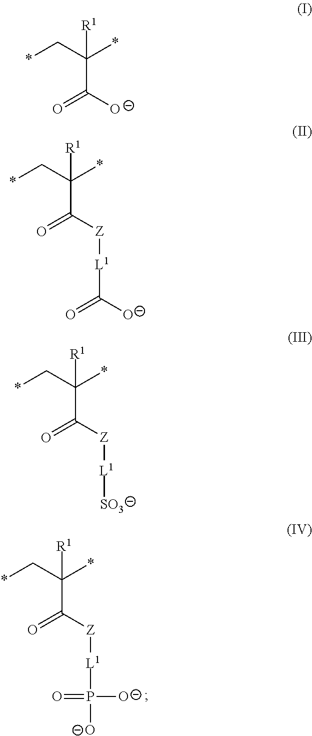
wherein in the foregoing Formulas,
R¹ is H or methyl;
L¹ is a divalent linking group; and
Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group; and
wherein the polycation comprises repeating units of formula (V) 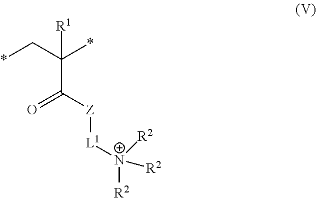
wherein
R¹ is H or methyl;
L¹ is a divalent linking group;
Z is independently at each occurrence —O— or —NH— or —NR—, wherein R is a substituted or unsubstituted C₆₋₂₀ aryl group, a C₁₋₂₀ alkylene oxide group, or a poly(C₁₋₆ alkylene oxide) group; and
R² is independently at each occurrence a substituted or unsubstituted C₁₋₂₀ alkyl group.

19. (canceled)

20. The method of claim 17, wherein the salt comprises an alkali metal salt, a transition metal salt, a lanthanide metal salt, an actinide metal salt, a volatile salt, or a combination thereof.

21. The method of claim 17, wherein curing the liquid complex coacervate comprises exposing the liquid complex coacervate to conditions effective to remove the salt, wherein conditions effective to remove the salt comprise washing the liquid complex coacervate with water or exposing the deposited liquid complex coacervate to a temperature and pressure effective to volatilize the salt.

22. (canceled)

23. (canceled)

24. A coating prepared by the method according to claim 17.

25. A precursor system comprising
a first component comprising a polyanion comprises repeating units comprising one or more of a carboxylate group, a sulfonate group, a phosphonate group, a sulfate group, or a phosphate group, and
a second component comprising a polycation comprises repeating units comprising one or more of a nitrogen-containing cationic group, a phosphorus-containing cationic group, or a sulfur-containing cationic group;
wherein at least one of the first component or the second component comprise a salt.

26. The precursor system of claim 25,
wherein the polyanion comprises repeating units of one or more of formulas (I)—(IV) 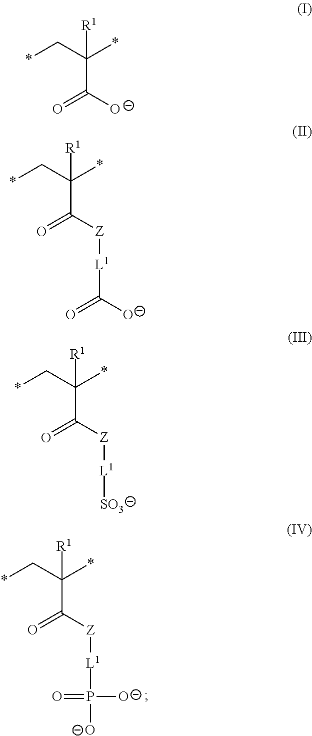
and
wherein the polycation comprises repeating units of formula (V) 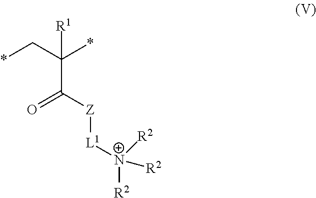
wherein in the foregoing Formulas,
R¹ is H or methyl;
R² is independently at each occurrence a substituted or unsubstituted C₁₋₂₀ alkyl group;
L¹ is a divalent linking group; and
Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group.

27. The precursor system of claim 25, wherein the salt comprises an alkali metal salt, a transition metal salt, a lanthanide metal salt, an actinide metal salt, a volatile salt, or a combination thereof.

28. A liquid complex coacervate product comprising
a macroion phase comprising a polyanion, a polycation, and a salt; and
optionally, a water-rich phase.

29. The liquid complex coacervate product of claim 28,
wherein the polyanion comprises repeating units of one or more of formulas (I)—(IV) 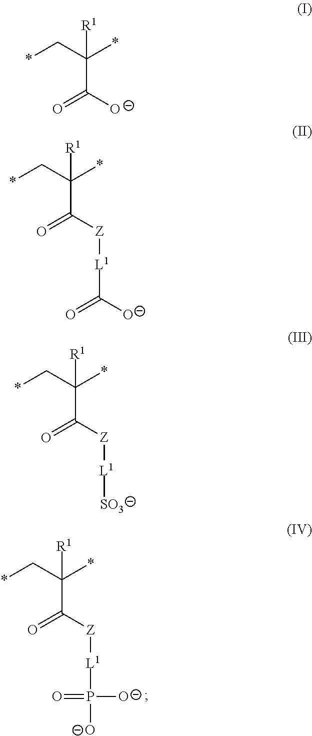
and
wherein the polycation comprises repeating units of formula (V) 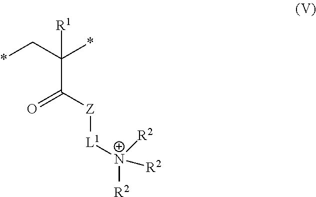
wherein in the foregoing Formulas,
R¹ is H or methyl;
R² is independently at each occurrence a substituted or unsubstituted C₁₋₂₀ alkyl group;
L¹ is a divalent linking group; and
Z is independently at each occurrence —O— or —NH— or —NR—, wherein R is a substituted or unsubstituted C₁₋₁₂ alkyl group, a substituted or unsubstituted C₃₋₁₂ cycloalkyl group, a substituted or unsubstituted C₆₋₂₀ aryl group, a C₁₋₂₀ alkylene oxide group, or a poly(C₁₋₆ alkylene oxide) group; and
wherein the salt comprises an alkali metal salt, a transition metal salt, a lanthanide metal salt, an actinide metal salt, a volatile salt, or a combination thereof.

30. (canceled)
